(19) United States
(12) Patent Application Publication
(10) Pub. No.: US 2026/0135236 A1
(43) Pub. Date: May 14, 2026

(54) POWER STORAGE DEVICE

(71) Applicant: TOYOTA JIDOSHA KABUSHIKI KAISHA, Toyota-shi (JP)

(72) Inventors: Makoto IWATA, Toyota-shi (JP); Shotaro Ishikawa, Miyoshi-shi (JP); Shunsuke Fujiwara, Toyota-shi (JP); Soichiro Nakamura, Toyota-shi (JP); Takahiko Nakano, Toyota-shi (JP); Kosuke Suzuki, Toyota-shi (JP); Masahiro Ishizuka, Toyota-shi (JP); Kensuke Matsuo, Seto-shi (JP); Kazuya Kumazawa, Nagoya-shi (JP)

(73) Assignee: TOYOTA JIDOSHA KABUSHIKI KAISHA, Toyota-shi (JP)

(21) Appl. No.: 19/267,978

(22) Filed: Jul. 14, 2025

(30) Foreign Application Priority Data
Nov. 13, 2024 (JP) 2024-198358

(51) Int. Cl. H01M 50/293; H01M 50/209; H01M 50/249; H01M 50/262; H01M 50/271; H01M 50/325; H01M 50/358

(52) U.S. Cl. CPC H01M 50/293; H01M 50/209; H01M 50/249; H01M 50/262; H01M 50/271; H01M 50/325; H01M 50/358; H01M 2220/20

(57) ABSTRACT

A power storage device includes a plurality of power storage cells, a bottom wall, a panel member, and a pair of restraining portions. Safety valves are provided in the lower surfaces of the power storage cells. The bottom wall has a plurality of through holes and an insertion hole through which at least one of the restraining portions is provided. At least one of the restraining portions includes a base disposed in an exhaust path. The restraining portions are configured to reduce a restraining force for restraining the power storage cells when the temperature of the base is equal to or greater than a reference value.

### CROSS-REFERENCE TO RELATED APPLICATION

This application claims priority to Japanese Patent Application No. 2024-198358 filed on Nov. 13, 2024. The disclosure of the above-identified application, including the specification, drawings, and claims, is incorporated by reference herein in its entirety.

### BACKGROUND

### 1. Technical Field

The present disclosure relates to a power storage device.

### 2. Description of Related Art

For example, Japanese Unexamined Patent Application Publication No. 2023-126584 (JP 2023-126584 A) discloses a battery including a plurality of cells, a case that houses the cells, a protective member that protects a bottom portion of the case, and a cover. Each of the cells includes a box that houses an electrode assembly. A relief mechanism is provided in a bottom surface of the box. Exhaust discharged from the relief mechanism flows into a collection cavity formed between the bottom portion of the case and the protective member.

### SUMMARY

In the battery described in JP 2023-126584 A, when the cell generates heat due to a short circuit etc. occurring in the electrode assembly, it may be necessary to reduce the amount of heat transferred from the cell generating heat to a cell adjacent to that cell.

An object of the present disclosure is to provide a power storage device that can suppress heat transfer from a power storage cell generating heat to a power storage cell adjacent to that power storage cell.

A power storage device according to one aspect of the present disclosure includes: a plurality of power storage cells arranged along one direction; a bottom wall disposed below the power storage cells; a panel member provided below the bottom wall and defining an exhaust path together with the bottom wall; and a pair of restraining portions that restrains the power storage cells from both sides of the power storage cells in the one direction. Safety valves are provided in lower surfaces of the power storage cells. The bottom wall has: a plurality of through holes positioned to face the safety valves; and an insertion hole through which at least one of the restraining portions is provided. At least one of the restraining portions includes a base disposed in the exhaust path. The restraining portions are configured to reduce a restraining force for restraining the power storage cells when a temperature of the base is equal to or greater than a reference value.

According to the present disclosure, it is possible to provide the power storage device that can suppress heat transfer from the power storage cell generating heat to the power storage cell adjacent to that power storage cell.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view schematically showing a power storage device according to an embodiment of the present disclosure;

FIG. 2 is a plan view schematically showing the power storage device with an upper cover removed;

FIG. 3 is a sectional view taken along line III-III in FIG. 2; and

FIG. 4 is a sectional view schematically showing a modification of restraining portions.

### DETAILED DESCRIPTION OF EMBODIMENTS

An embodiment of the present disclosure will be described with reference to the drawings. In the drawings referred to below, the same or corresponding members are given the same numbers.

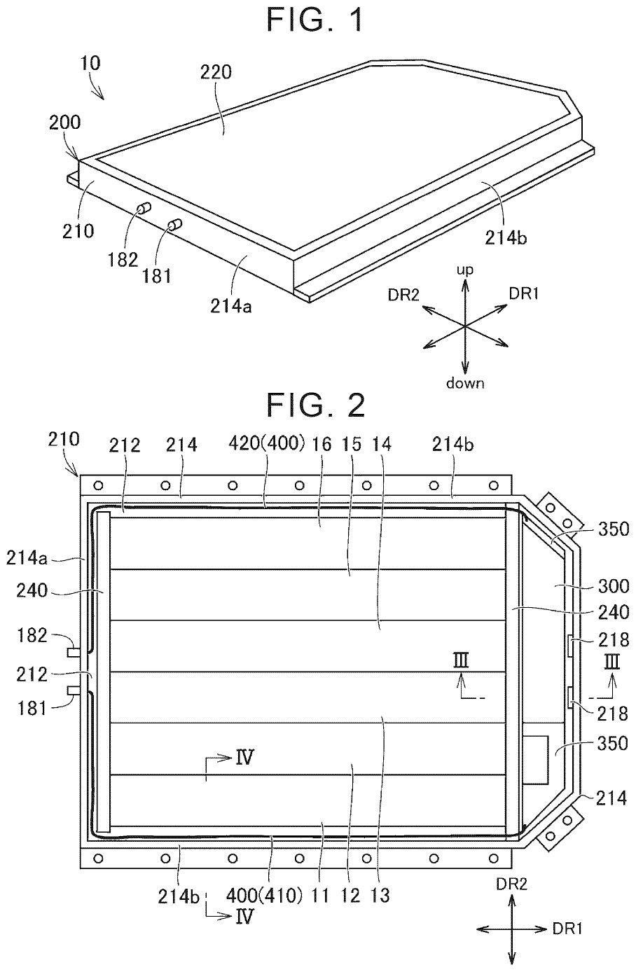

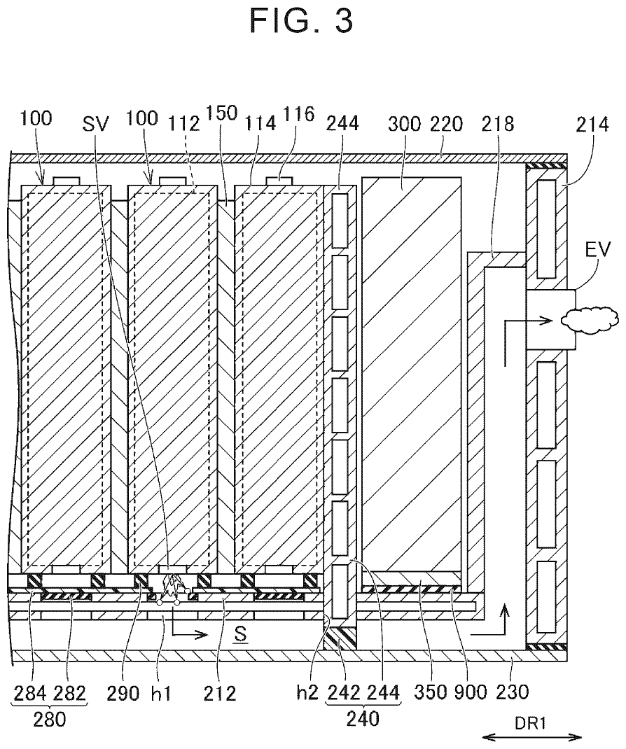

FIG. 1 is a perspective view schematically showing a power storage device according to an embodiment of the present disclosure. FIG. 2 is a plan view schematically showing the power storage device with an upper cover removed. FIG. 3 is a sectional view taken along line III-III in FIG. 2.

A power storage device 10 according to the present embodiment is mounted, for example, on a lower part of a vehicle. Examples of the vehicle include a hybrid electric vehicle, a plug-in hybrid electric vehicle, and a battery electric vehicle.

As shown in FIGS. 1 to 3, the power storage device 10 includes six power storage stacks 11 to 16, a housing 200, a protective member 280, devices 300, a device cooler 350, and a cooling medium pipe 400. The number of power storage stacks is not limited to six.

Each of the power storage stacks 11 to 16 has a rectangular parallelepiped shape that is elongated in a first direction DR1. As shown in FIG. 2, the six power storage stacks 11 to 16 are arranged along a second direction DR2 that is perpendicular to both the first direction DR1 and an up-down direction. In the present embodiment, the first direction DR1 corresponds to the front-rear direction of the vehicle, and the second direction DR2 corresponds to the right-left direction (width direction) of the vehicle. Each of the power storage stacks 11 to 16 includes at least one power storage cell 100. In the present embodiment, each of the power storage stacks 11 to 16 includes a plurality of power storage cells 100 and a plurality of cooling plates 150.

The power storage cells 100 are arranged along the first direction DR1. As shown in FIG. 3, each power storage cell 100 includes an electrode assembly 112, a cell case 114, and a pair of external terminals 116.

The electrode assembly 112 may be a wound electrode assembly in which a cathode sheet and an anode sheet are wound with a separator interposed therebetween, or may be a laminate in which a cathode sheet and an anode sheet are laminated with a separator interposed therebetween. The electrode assembly 112 has a shape that is elongated in the second direction DR2.

The cell case 114 houses the electrode assembly 112. The cell case 114 has a rectangular parallelepiped shape. The cell case 114 is made of a metal such as aluminum. A safety valve SV is provided in a lower surface of the cell case 114.

The external terminals 116 are provided on an upper surface of the cell case 114. The external terminals 116 are provided at positions spaced apart from each other in the width direction of the cell case 114. The width direction of the cell case 114 corresponds to the second direction DR2.

As shown in FIG. 3, each cooling plate 150 is disposed between a pair of power storage cells 100 adjacent to each other in the first direction DR1. Each cooling plate 150 has a flat plate shape that is elongated in the second direction DR2. Each cooling plate 150 has a channel (not shown) for a cooling medium along the second direction DR2.

The housing 200 houses the six power storage stacks 11 to 16. As shown in FIGS. 1 to 3, the housing 200 includes a lower case 210, an upper cover 220, a panel member 230, and a pair of restraining portions 240.

The lower case 210 is open upward. The lower case 210 may be made of a metal such as aluminum. The lower case 210 includes a bottom wall 212 and a peripheral wall 214.

The bottom wall 212 is located below the power storage stacks 11 to 16. In the present embodiment, the bottom wall 212 is hollow. The bottom wall 212 may be formed by extrusion molding. The bottom wall 212 may be formed as a solid and flat plate.

As shown in FIG. 3, the bottom wall 212 has a plurality of through holes h1 and a pair of insertion holes h2. Only one of the insertion holes h2 is shown in FIG. 3.

Each through hole h1 is positioned to face a corresponding safety valve SV. The length of the through hole h1 in the first direction DR1 is greater than the length of the safety valve SV in the first direction DR1.

Each insertion hole h2 is a through hole through which the restraining portion 240 is inserted. Each insertion hole h2 extends in the second direction DR2. One of the insertion holes h2 may be omitted.

The protective member 280 is provided on the bottom wall 212. As shown in FIG. 3, the protective member 280 includes a plurality of thermal insulation members 282 and a holding sheet 284.

Each thermal insulation member 282 is provided within a corresponding through hole h1. Each thermal insulation member 282 is shaped to close a corresponding through hole h1. In the present embodiment, the upper surfaces of the thermal insulation members 282 are set to be flush with the upper surface of the bottom wall 212. Each thermal insulation member 282 serves to protect a corresponding power storage cell 100 from gas discharged from a corresponding safety valve SV. The thermal insulation member 282 is made of, for example, mica solidified by thermally pressing a natural inorganic mineral.

The holding sheet 284 holds the thermal insulation members 282. The thermal insulation members 282 may be bonded to the back surface of the holding sheet 284. The holding sheet 284 is made of, for example, polypropylene.

The peripheral wall 214 stands from a peripheral edge of the bottom wall 212. The peripheral wall 214 is shaped to surround the power storage stacks 11 to 16. The peripheral wall 214 may be hollow. The peripheral wall 214 includes a front wall 214a and a pair of side walls 214b.

The front wall 214a is formed on one side (left side in FIG. 2) of the power storage stacks 11 to 16 in the first direction DR1. The front wall 214a extends in the second direction DR2. In the present embodiment, the one side in the first direction DR1 corresponds to a front side in the front-rear direction of the vehicle.

The side walls 214b face each other at a distance in the second direction DR2. The side walls 214b extend in the first direction DR1. An end (front end) of each side wall 214b on the one side in the first direction DR1 is connected to the front wall 214a.

The upper cover 220 is disposed above the power storage stacks 11 to 16. The upper cover 220, together with the lower case 210, houses the six power storage stacks 11 to 16. Specifically, the upper cover 220, together with the lower case 210, houses the six power storage stacks 11 to 16 in a sealed state. The peripheral edge of the upper cover 220 is connected to the upper end of the peripheral wall 214 via a sealing member by bolts etc.

The panel member 230 is provided below the lower case 210. The panel member 230 serves to protect the bottom wall 212 of the lower case 210. The panel member 230 may have a flat plate shape. The peripheral edge of the panel member 230 is connected to the lower surface of the lower case 210 via a sealing member.

As shown in FIG. 3, a space S is formed between the panel member 230 and the bottom wall 212. The space S serves as an exhaust path (hereinafter referred to as “exhaust path S”). The exhaust path S is a path along which gas discharged from the safety valves SV of the power storage cells 100 is discharged to the outside of the housing 200.

As shown in FIGS. 2 and 3, an exhaust duct 218 is formed on the peripheral wall 214. The exhaust duct 218 extends upward from the bottom wall 212. The exhaust duct 218 guides the gas upward from the exhaust path S. A relief valve EV is provided at the downstream end of the exhaust duct 218. The relief valve EV releases pressure within the housing 200. The relief valve EV opens when the pressure within the housing 200 is equal to or greater than a reference value. The relief valve EV is a check valve. As shown in FIG. 3, when gas is discharged from any of the power storage cells 100, the gas spreads in the first direction DR1 through the exhaust path S and is discharged to the outside of the housing 200 through the exhaust duct 218 and the relief valve EV.

The restraining portions 240 restrain the power storage cells 100 from both sides of the power storage cells 100 in the first direction DR1. More specifically, the restraining portions 240 restrain the power storage stacks 11 to 16 from both sides in the first direction DR1. The restraining portions 240 extend in the second direction DR2. As shown in FIG. 2, the restraining portions 240 divide the space surrounded by the bottom wall 212 and the peripheral wall 214 into a space in which the power storage stacks 11 to 16 are disposed and the other space. The ends in the second direction DR2 for the restraining portion 240 formed on the one side (front side) in the first direction DR1 are spaced apart from the side walls 214b. The ends in the second direction DR2 for the restraining portion 240 formed on the other side (rear side) in the first direction DR1 are connected to the side walls 214b.

As shown in FIG. 3, at least one of the restraining portions 240 includes a base 242 and a restraining portion body 244. In the present embodiment, each of the restraining portions 240 includes the base 242 and the restraining portion body 244.

The base 242 is disposed in the exhaust path S. The lower surface of the base 242 may be in contact with the panel member 230. The upper surface of the base 242 may be located below the lower surface of the bottom wall 212 or may be located within the insertion hole h2.

The restraining portion body 244 extends upward from the base 242. The lower part of the restraining portion body 244 is inserted into the insertion hole h2. The pair of restraining portion bodies 244 exerts a restraining force on the power storage cells 100. The restraining portion body 244 is made of a metal such as aluminum. The restraining portion body 244 may be hollow. The upper surface of the restraining portion body 244 may be formed flush with the upper surface of the cell case 114, may be formed at a higher position than the upper surface of the cell case 114, or may be formed at a lower position than the upper surface of the cell case 114. A spacer (not shown) may be provided between the restraining portion body 244 and the power storage cell 100 disposed at the end in the first direction DR1.

The restraining portions 240 are configured to reduce the restraining force for restraining the power storage cells 100 when the temperature of the base 242 is equal to or greater than a reference value. In the present embodiment, the base 242 is made of a material that softens when the temperature of the base 242 is equal to or greater than the reference value. The base 242 is made of, for example, a synthetic resin having a softening point equal to or less than the reference value.

As shown in FIG. 3, the power storage device 10 may include surrounding members 290. The surrounding member 290 is provided between the lower surface of the power storage cell 100 and the upper surface of the bottom wall 212. The surrounding member 290 is shaped to surround each through hole h1. In the present embodiment, the surrounding member 290 is provided between the bottom surface of each cell case 114 and the holding sheet 284. The lower surface of the surrounding member 290 is in contact with the holding sheet 284 located on the upper surface of the bottom wall 212. The upper surface of the surrounding member 290 may be in contact with the bottom surface of the cell case 114. The surrounding member 290 is made of a resin, a metal, etc. The surrounding member 290 may be in contact with the lower surface of the cooling plate 150.

The devices 300 are housed in the housing 200. As shown in FIG. 2, the devices 300 are disposed on the other side of the lower case 210 in the first direction DR1, that is, in a space formed between a partition wall 216 formed on the other side (rear side) in the first direction DR1 and the peripheral wall 214. The devices 300 may include a junction box. The devices 300 may include a relay, a control device, etc.

The device cooler 350 cools the devices 300. As shown in FIGS. 2 and 3, the device cooler 350 is provided between the bottom wall 212 and the devices 300. A thermally conductive adhesive 900 may be provided between the device cooler 350 and the bottom wall 212.

The cooling medium pipe 400 is routed within the housing 200. The cooling medium pipe 400 is connected to the cooling plates 150 and the device cooler 350. As shown in FIGS. 1 and 2, the front wall 214a of the peripheral wall 214 is provided with an inlet port 181 and an outlet port 182. The cooling medium pipe 400 is connected to the inlet port 181 and the outlet port 182. Accordingly, the cooling medium (water, oil, etc.) supplied from the inlet port 181 flows into the cooling plates 150 and the device cooler 350 through the cooling medium pipe 400, cools the power storage cells 100 and the devices 300, and then flows out from the outlet port 182 through the cooling medium pipe 400.

As shown in FIG. 2, the cooling medium pipe 400 includes an upstream pipe 410 and a downstream pipe 420.

The upstream end of the upstream pipe 410 is connected to the inlet port 181. The downstream end of the upstream pipe 410 is connected to one end of the device cooler 350 in the second direction DR2. The upstream pipe 410 is routed to pass between the front wall 214a and the restraining portion 240 formed on the one side in the first direction DR1, and between the power storage stack 11 disposed on one side in the second direction DR2 and the side wall 214b. The upstream pipe 410 is connected to one end of each cooling plate 150 in the second direction DR2.

The upstream end of the downstream pipe 420 is connected to the other end of the device cooler 350 in the second direction DR2. The downstream end of the downstream pipe 420 is connected to the outlet port 182. The downstream pipe 420 is routed to pass between the front wall 214a and the restraining portion 240 formed on the one side in the first direction DR1, and between the power storage stack 16 disposed on the other side in the second direction DR2 and the side wall 214b. The downstream pipe 420 is connected to the other end of each cooling plate 150 in the second direction DR2.

In the power storage device 10 described above, when exhaust is discharged downward from the safety valve SV due to a short circuit etc. in any of the power storage cells 100, the exhaust impinges against the holding sheet 284 and the thermal insulation member 282. Then, the holding sheet 284 melts and the thermal insulation member 282 breaks open. Therefore, the exhaust containing the content (so-called debris) of the power storage cell 100 flows into the exhaust path S through the through hole h1. Gas contained in the exhaust then spreads through the exhaust path S.

At this time, the gas comes into contact with the base 242 to heat the base 242. As a result, the temperature of the base 242 becomes equal to or greater than the reference value, and the restraining force of the restraining portions 240 for the power storage cells 100 decreases. Therefore, the transfer of heat from the power storage cell 100 generating heat to the power storage cell 100 adjacent to that power storage cell 100 is suppressed.

The gas is then discharged from the housing 200 through the relief valve EV as shown in FIG. 3. Thus, adhesion of the content of the power storage cell 100 to the external terminals 116 etc. is suppressed.

A modification of the above embodiment will be described below.

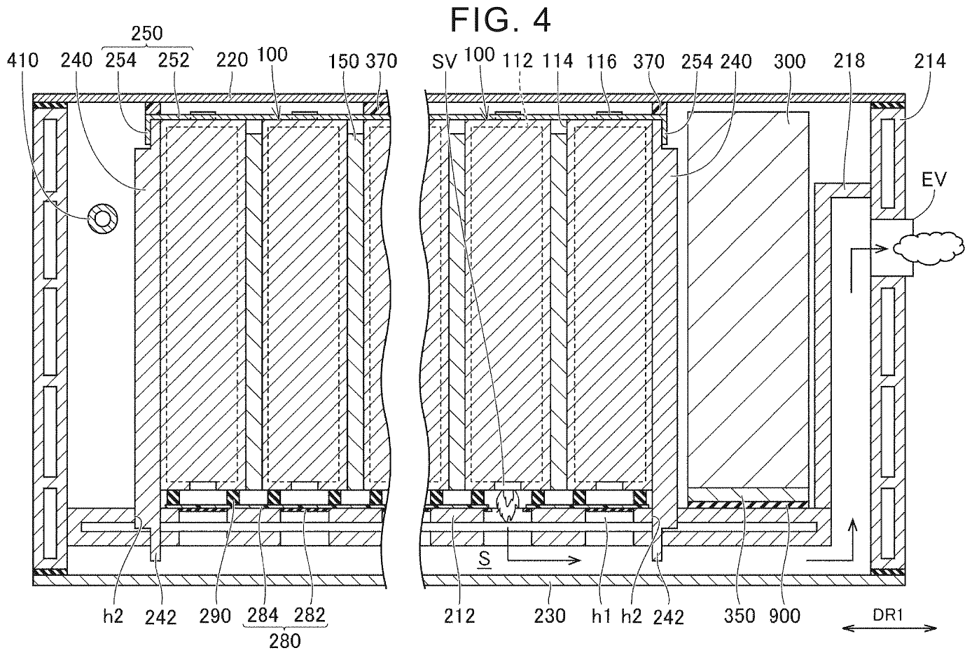

As shown in FIG. 4, the power storage device 10 may further include a restraining band 250. In this example, each restraining portion 240 is a restraining plate (hereinafter referred to as “restraining plate 240”) made of a metal. The base 242 of the restraining plate 240 is located in the exhaust path S.

The restraining band 250 connects the restraining plates 240 together. The restraining band 250 is made of a metal. The restraining band 250 is in thermal contact with each of the restraining plates 240. The restraining band 250 expands to reduce the restraining force when the temperature of the restraining band 250 is equal to or greater than the reference value. In the example shown in FIG. 4, the restraining band 250 is disposed above each of the power storage stacks 11 to 16. As shown in FIG. 4, the restraining band 250 includes a band body 252 and fixing portions 254.

The band body 252 has a flat plate shape. The band body 252 is disposed on the upper surface of each cell case 114 at a portion between the external terminals 116. The band body 252 may be bonded to the upper surface of the cell case 114. It is preferable that the thickness (dimension in the up-down direction) of the band body 252 be equal to or less than the sum of the thickness of each external terminal 116 and the thickness of a busbar (not shown) connected to the external terminal 116. The band body 252 extends from one of the restraining plates 240 to the other. From the viewpoint of increasing the bending rigidity of the band body 252, a bead (not shown) extending in the first direction DR1 may be formed on the band body 252. Alternatively, a protruding ridge (not shown) extending in the first direction DR1 may be formed on at least one of the upper and lower surfaces of the band body 252.

The fixing portion 254 is connected to the end of the band body 252 in the first direction DR1. As shown in FIG. 4, the fixing portion 254 is fixed to the outer surface of the corresponding restraining plate 240 in the first direction DR1 by a fastening member (not shown) etc.

The power storage device 10 may further include an interposition member 370. The interposition member 370 is interposed between the band body 252 and the upper cover 220. A plurality of interposition members 370 may be disposed at intervals in the first direction DR1. Alternatively, a single interposition member 370 may be disposed between the band body 252 and the upper cover 220. The interposition member 370 is made of a resin, a metal, etc.

In the present embodiment, when gas flows into the exhaust path S, heat of the gas is transferred from the base 242 to the restraining band 250 through the restraining plate 240. When the temperature of the restraining band 250 becomes equal to or greater than the reference value, the restraining band 250 expands and the restraining force exerted by the restraining plates 240 decreases.

In the present embodiment, when the internal pressure of the cell case 114 increases due to a short circuit etc., the band body 252 is bonded to the upper surface of the cell case 114. Therefore, the rupture of the upper surface of the cell case 114 is suppressed when the internal pressure of the cell case 114 increases. As a result, the exhaust from the power storage cell 100 is effectively discharged downward from the safety valve SV provided in the lower surface of the cell case 114.

It will be understood by a person skilled in the art that the exemplary embodiment described above is a specific example of the following aspects.

### First Aspect

A power storage device including:
a plurality of power storage cells arranged along one direction;
a bottom wall disposed below the power storage cells;
a panel member provided below the bottom wall and defining an exhaust path together with the bottom wall; and
a pair of restraining portions that restrains the power storage cells from both sides of the power storage cells in the one direction, in which
safety valves are provided in lower surfaces of the power storage cells,
the bottom wall has:
   a plurality of through holes positioned to face the safety valves; and
   an insertion hole through which at least one of the restraining portions is provided,
at least one of the restraining portions includes a base disposed in the exhaust path, and
the restraining portions are configured to reduce a restraining force for restraining the power storage cells when a temperature of the base is equal to or greater than a reference value.

In this power storage device, when gas discharged from the safety valve of the power storage cell and flowing into the exhaust path through the through hole spreads in the exhaust path, the gas comes into contact with the base and heats the base. As a result, the temperature of the base becomes equal to or greater than the reference value, and the restraining force of the restraining portions for the power storage cells decreases. Therefore, the transfer of heat from the power storage cell generating heat to the power storage cell adjacent to that power storage cell is suppressed.

### Second Aspect

The power storage device according to the first aspect, in which:
one of the restraining portions further includes a restraining portion body extending upward from the base;
the restraining portion body, together with the other of the restraining portions, applies the restraining force to the power storage cells; and
the base is made of a material that softens when the temperature of the base is equal to or greater than the reference value.

In this aspect, when the gas flowing into the exhaust path comes into contact with the base and the temperature of the base becomes equal to or greater than the reference value, the base softens and the restraining force exerted by the restraining portion body decreases.

### Third Aspect

The power storage device according to the first aspect, further including a restraining band that is in thermal contact with the restraining portions and connects the restraining portions together, in which:
at least one of the restraining portions includes a restraining plate including the base; and
the restraining band expands to reduce the restraining force when a temperature of the restraining band becomes equal to or greater than the reference value.

In this aspect, when the gas flows into the exhaust path, the heat of the gas is transferred from the base to the restraining band via the restraining plate. Therefore, the restraining band expands to reduce the restraining force.

### Fourth Aspect

The power storage device according to the third aspect, further including:
an upper cover disposed above the power storage cells; and
an interposition member interposed between the restraining band and the upper cover.

In this aspect, the restraining band is retained from above by the interposition member and the upper cover. Therefore, the rupture of the upper surface of the power storage cell is suppressed when the internal pressure of the power storage cell increases.

The embodiment disclosed herein should be considered to be illustrative in all respects and not restrictive. The scope of the present disclosure is set forth in the claims rather than in the above description of the embodiment, and is intended to include all modifications within the meaning and scope equivalent to the claims.

What is claimed is:

1. A power storage device comprising:
a plurality of power storage cells arranged along one direction;
a bottom wall disposed below the power storage cells;
a panel member provided below the bottom wall and defining an exhaust path together with the bottom wall; and
a pair of restraining portions that restrains the power storage cells from both sides of the power storage cells in the one direction, wherein
safety valves are provided in lower surfaces of the power storage cells,
the bottom wall has:
a plurality of through holes positioned to face the safety valves; and
an insertion hole through which at least one of the restraining portions is provided,
at least one of the restraining portions includes a base disposed in the exhaust path, and
the restraining portions are configured to reduce a restraining force for restraining the power storage cells when a temperature of the base is equal to or greater than a reference value.

2. The power storage device according to claim 1, wherein:
one of the restraining portions further includes a restraining portion body extending upward from the base;
the restraining portion body, together with the other of the restraining portions, applies the restraining force to the power storage cells; and
the base is made of a material that softens when the temperature of the base is equal to or greater than the reference value.

3. The power storage device according to claim 1, further comprising a restraining band that is in thermal contact with the restraining portions and connects the restraining portions together, wherein:
at least one of the restraining portions includes a restraining plate including the base; and
the restraining band expands to reduce the restraining force when a temperature of the restraining band becomes equal to or greater than the reference value.

4. The power storage device according to claim 3, further comprising:
an upper cover disposed above the power storage cells; and
an interposition member interposed between the restraining band and the upper cover.
